(19) United States
(12) Patent Application Publication
(10) Pub. No.: US 2018/0099542 A1
(43) Pub. Date: Apr. 12, 2018

(54) COOLING DEVICE, AND AIR-CONDITIONER FOR VEHICLE

(71) Applicant: DENSO CORPORATION, Kariya-city, Aichi-pref. (JP)

(72) Inventors: Daisuke SAKAKIBARA, Kariya-city (JP); Koji ITO, Kariya-city (JP); Yasuhiro SEKITO, Kariya-city (JP); Takahito NAKAMURA, Kariya-city (JP); Shinya KATO, Kariya-city (JP)

(73) Assignee: DENSO CORPORATION, Kariya-city, Aichi-pref. (JP)

(21) Appl. No.: 15/561,312

(22) PCT Filed: Mar. 8, 2016
(86) PCT No.: PCT/JP2016/057234

§ 371 Date: Sep. 25, 2017

(30) Foreign Application Priority Data
Apr. 1, 2015 (JP) 2015-075289

(51) Int. Cl. B60H 3/02; B60H 1/00; B01D 53/26

(52) U.S. Cl. CPC B60H 3/02; B60H 1/00271; B60H 2001/003; B60H 2003/028; B01D 53/261

(57) ABSTRACT

A cooling device is applied to an in-vehicle equipment having a cooling unit which cools air, and cools an in-vehicle heat-emitting apparatus with the air cooled by the cooling unit. The cooling device includes: an adsorption unit including an adsorption material which adsorbs moisture; an adsorption case that defines a housing space in which the adsorption unit is disposed, the air cooled by the cooling unit passing through the adsorption case, the adsorption material adsorbing moisture from the air; and a cooling air outlet part that guides a dehumidification air, from which the moisture is adsorbed within the adsorption case, to a target space to be cooled where the heat-emitting apparatus is arranged.

### CROSS REFERENCE TO RELATED APPLICATION

This application is based on Japanese Patent Application No. 2015-75289 filed on Apr. 1, 2015, the disclosure of which is incorporated herein by reference.

### TECHNICAL FIELD

The present disclosure relates to a cooling device for an in-vehicle equipment including a cooling unit, and an air-conditioner with the cooling device for a vehicle.

### BACKGROUND ART

Conventionally, a temperature adjustment equipment is known, by which air cooled by an air-conditioning unit cools a battery (namely, electricity accumulation object) that is an in-vehicle heat-emitting apparatus (for example, refer to Patent Literature 1). Patent Literature 1 discloses an example in which a battery is cooled by air cooled by an evaporator of an air-conditioning unit.

### PRIOR ART LITERATURES

### Patent Literature

### Patent Literature 1: JP 2013-212829 A

### SUMMARY OF INVENTION

In the temperature adjustment equipment of Patent Literature 1, the air cooled by the evaporator of the air-conditioning unit is introduced as it is into a space where the heat-emitting apparatus is arranged (namely, electric passage of a group battery). In such a configuration, the heat-emitting apparatus is cooled with the high-humidity air (namely, air with high relative humidity). For this reason, dew condensation may be generated around the heat-emitting apparatus.

The present disclosure aims to provide a cooling device and an air-conditioner, by which an in-vehicle heat-emitting apparatus can be cooled while dew condensation is restricted.

According to an aspect of the present disclosure, a cooling device is applied to an in-vehicle equipment having a cooling unit which cools air, and cools an in-vehicle heat-emitting apparatus with the air cooled by the cooling unit.

The cooling device of the present disclosure includes:

an adsorption unit including an adsorption material which adsorbs moisture;

an adsorption case that defines a housing space in which the adsorption unit is disposed, the air cooled by the cooling unit passing through the adsorption case, the adsorption material adsorbing moisture from the air; and

a cooling air outlet part that guides a dehumidification air, from which the moisture is adsorbed within the adsorption case, to a target space to be cooled where the heat-emitting apparatus is arranged.

According to another aspect of the present disclosure, an air conditioner for a vehicle includes: an in-vehicle equipment equipped with a cooling unit which cools air; and a cooling device which cools an in-vehicle heat-emitting apparatus with the air cooled by the cooling unit.

In the air conditioner of the present disclosure, the cooling device includes

an adsorption unit including an adsorption material which adsorbs moisture,

an adsorption case that defines a housing space in which the adsorption unit is disposed, the air cooled by the cooling unit passing through the adsorption case, the adsorption material adsorbing moisture from the air, and

a cooling air outlet part that guides a dehumidification air, from which the moisture is adsorbed within the adsorption case, to a target space to be cooled where the heat-emitting apparatus is arranged.

Accordingly, the air dehumidified by the adsorption material of the adsorption unit after being cooled by the cooling unit of the in-vehicle equipment can flow into the target space where the in-vehicle heat-emitting apparatus is arranged. For this reason, compared with a case where air cooled by the cooling unit flows into the target space as it is, dew condensation is restricted from being generated on the surface or around the heat-emitting apparatus.

Therefore, according to the cooling device and the air-conditioner of the present disclosure, it becomes possible to restrict the dew condensation while the in-vehicle heat-emitting apparatus is cooled.

### BRIEF DESCRIPTION OF DRAWINGS

FIG. 1 is a schematic sectional view illustrating an air-conditioner for a vehicle equipped with a cooling device according to a first embodiment.

FIG. 2 is a block diagram illustrating a control device of the cooling device and an air-conditioning unit of the first embodiment.

FIG. 3 is a flow chart showing a flow of control processing of the cooling device executed by the control device of the first embodiment.

FIG. 4 is a schematic sectional view illustrating an operation state of the cooling device of the first embodiment.

FIG. 5 is a schematic sectional view illustrating an air-conditioner for a vehicle equipped with a cooling device according to a second embodiment.

FIG. 6 is a perspective view mainly illustrating the cooling device of the second embodiment.

FIG. 7 is a view seen in an arrow direction VII of FIG. 6.

FIG. 8 is a perspective view schematically illustrating a heat exchanger of the second embodiment.

FIG. 9 is a block diagram illustrating a control device of the cooling device and an air-conditioning unit of the second embodiment.

FIG. 10 is a flow chart showing a flow of control processing of the cooling device executed by the control device of the second embodiment.

FIG. 11 is a schematic sectional view illustrating an operation state of the cooling device of the second embodiment at a time of cooling and humidifying process.

FIG. 12 is a schematic sectional view illustrating an operation state of the cooling device of the second embodiment at a time of humidifying process.

FIG. 13 is a schematic sectional view illustrating an air-conditioner for a vehicle equipped with a cooling device according to a third embodiment.

### DESCRIPTION OF EMBODIMENTS

Embodiments of the present disclosure will be described below with reference to the accompanying drawings. In the following respective embodiments, the same or equivalent parts as the matters explained in the previous embodiment(s) are denoted by the same reference numerals, and the description thereof will be omitted in some cases. When only part of a component in each of the embodiments is explained, other parts of the component can be applied to components explained in the previous embodiment(s).

### First Embodiment

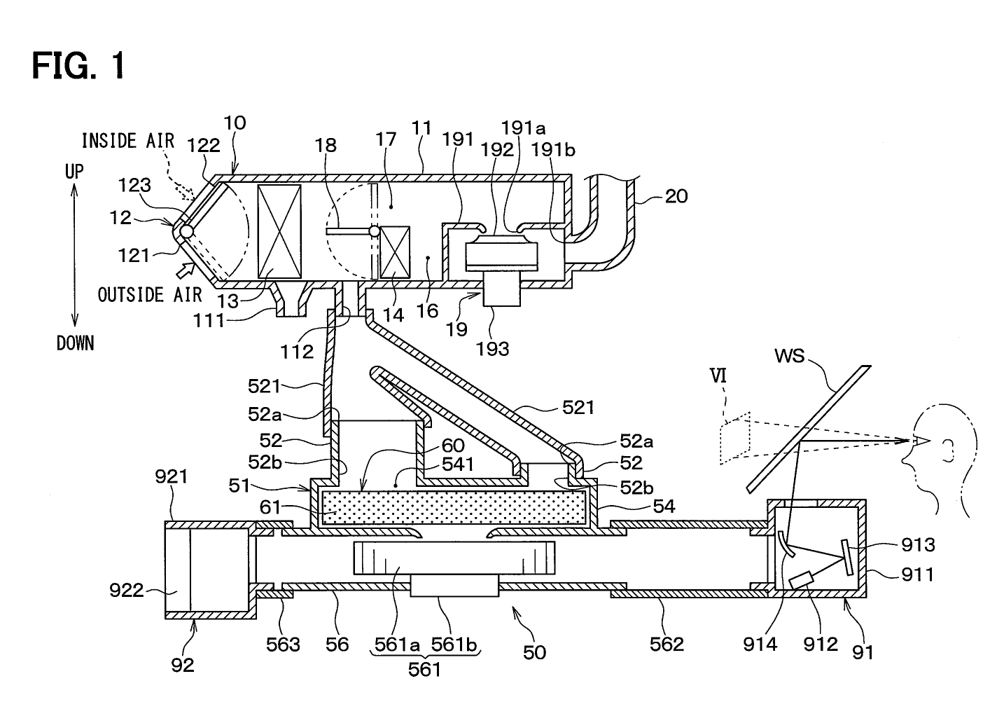

This embodiment will describe an example in which a vehicle air conditioner to perform air-conditioning of the vehicle interior is applied to a vehicle that obtains a driving force for vehicle traveling from a non-illustrated internal combustion engine (for example, engine). As shown in FIG. 1, the vehicle air conditioner includes an air-conditioning unit 10 corresponding to an in-vehicle equipment and a cooling device 50 as main components.

First, the air-conditioning unit 10 will be described. The air-conditioning unit 10 is disposed below a dashboard (i.e., an instrumental panel) in the vehicle interior. The air-conditioning unit 10 houses an evaporator 13 and a heater core 14 in an air-conditioning case 11 forming an outer shell of the air-conditioning unit.

The air-conditioning case 11 configures a ventilation passage through which the ventilation air is blown into the vehicle interior. The air-conditioning case 11 in this embodiment is formed of resin (for example, polypropylene) with some elasticity and excellent strength.

An inside/outside air switching box 12 is disposed at the most upstream side of the air flow in the air-conditioning case 11 so as to switch between air outside a vehicle compartment (i.e., the outside air) and air in the vehicle interior (i.e., the inside air) and introduce the switched air into the air-conditioning case. The inside/outside air switching box 12 is provided with an outside-air introduction port 121 for introducing the outside air and an inside-air introduction port 122 for introducing the inside air. Furthermore, within the inside/outside air switching box 12, an inside/outside air switching door 123 is disposed to change the ratio of the introduced volume of the outside air to the introduced volume of the inside air by adjusting opening areas of the respective introduction ports 121 and 122.

The inside/outside air switching door 123 is rotatably disposed between the outside-air introduction port 121 and the inside-air introduction port 122. The inside/outside air switching door 123 is driven by an actuator (not shown).

The evaporator 13 is disposed on the air-flow downstream side of the inside/outside air switching box 12 to configure a cooling unit which cools ventilation air to be sent into the vehicle interior. The evaporator 13 is a heat exchanger that absorbs, from the ventilation air, the latent heat of evaporation of a low-temperature refrigerant circulating therethrough, thereby cooling the ventilation air. The evaporator 13 configures a vapor compression refrigeration cycle together with a compressor, a condenser, and a decompression mechanism (all not shown).

A warm air passage 16 and a cold air bypass passage 17 are formed on the air-flow downstream side of the evaporator 13. The warm air passage 16 allows the air cooled by the evaporator 13 to flow toward the heater core 14. The cold air bypass passage 17 allows the air cooled by the evaporator 13 to flow bypassing the heater core 14.

The heater core 14 is a heat exchanger that heats the ventilation air by using a cooling water for the non-illustrated internal combustion engine (for example, engine) as a heat source. In this embodiment, the heater core 14 configures a heating portion that heats the ventilation air.

An air mixing door 18 is rotatably disposed between the evaporator 13 and the heater core 14. The air mixing door 18 is driven by an actuator (not shown) and regulates the temperature of the ventilation air to be blown into the vehicle interior by adjusting the ratio of the air passing through the warm air passage 16 to the air passing through the cold air bypass passage 17.

An air-conditioning blower 19 is disposed on the air-flow downstream side of the warm air passage 16 and the cold air bypass passage 17. The air-conditioning blower 19 generates an air flow within the air-conditioning case 11, to be blown into the vehicle interior. The air-conditioning blower 19 includes a blowing case 191, an air-conditioning fan 192, and an air-conditioning motor 193.

The blowing case 191 configures a part of the air-conditioning case 11. The blowing case 191 has a suction port 191a for air and a discharge port 191b from which the air drawn via the suction port 191a is discharged.

The air-conditioning fan 192 draws the air on the air-flow downstream side of the warm air passage 16 and the cold air bypass passage 17 via the suction port 191a and discharges the air from the discharge port 191b. The air-conditioning fan 192 in this embodiment is configured of a centrifugal fan that blows the air drawn thereinto in the axial direction toward the outside thereof in the radial direction. The air-conditioning fan 192 is rotatably driven by the air-conditioning motor 193. Note that the air-conditioning fan 192 is not limited to the centrifugal fan and may be configured of an axial fan, a cross flow fan, or the like.

The discharge port 191b of the air-conditioning blower 19 is connected to an air-conditioning duct 20. The air-conditioning duct 20 is a member that is opened within the vehicle interior and guides the ventilation air to outlet portions (not shown) to blow the air therefrom into the vehicle interior. Although not shown, the outlet portions include a face air outlet that blows air toward an upper body of an occupant, a foot air outlet that blows air toward a lower body of an occupant, and a defroster air outlet that blows air toward a windshield of the vehicle. The air-conditioning duct 20 or the blowing case 191 is provided with a mode switching door (not shown) that sets a blowing mode of the air from each air outlet. The mode switching door is driven by an actuator (not shown).

Here, the air-conditioning case 11 in this embodiment has a drain discharge portion 111 and a cold air guiding portion 112, which are formed on its bottom surface portion. The drain discharge portion 111 is an opening from which the condensed water generated in the evaporator 13 is discharged toward the outside of the vehicle. The drain discharge portion 111 in this embodiment is formed at a part of the bottom surface portion of the air-conditioning case 11 that faces a lower end of the evaporator 13.

The cold air guiding portion 112 is an opening through which a part of the ventilation air (i.e., cooled air) cooled by the evaporator 13 in the air-conditioning case 11 is guided toward the outside of the air-conditioning case 11. The cold air guiding portion 112 in this embodiment is formed at a position between the evaporator 13 and the heater core 14 at the bottom surface portion of the air-conditioning case 11. More specifically, the cold air guiding portion 112 is formed at the bottom surface portion positioned between the drain discharge portion 111 and the heater core 14.

Here, the air-conditioning unit 10 in this embodiment adopts a so-called suction type structure in which the air-conditioning blower 19 is disposed on the air-flow downstream side in the air-conditioning case 11. Thus, the internal pressure of the air-conditioning case 11 is lower than the pressure outside the air-conditioning case 11.

Subsequently, the cooling device 50 will be described. The cooling device 50 is disposed below the dashboard of the vehicle, like the air-conditioning unit 10. More specifically, the cooling device 50 is disposed on the lower side of the air-conditioning case 11 and in a position close to a part of the air-conditioning case 11 where the evaporator 13 is disposed, in such a manner as to make the cold air guiding portion 112 of the air-conditioning case 11 close to a cold air suction part 52 of the cooling device 50 to be described later.

The cooling device 50 houses an adsorption unit 60 in an adsorption case 51 forming an outer shell of the cooling device. The adsorption case 51 configures a ventilation passage for the ventilation air. The adsorption case 51 is a component separately formed from the air-conditioning case 11. The adsorption case 51 is mainly divided into a cold air suction part 52, an adsorption unit housing portion 54, and a cold air discharge part 56.

The cold air suction part 52 has plural first external introduction ports 52a communicating with the outside thereof. The cold air suction part 52 further has plural first internal communication ports 52b communicating with a moisture-adsorption space 541a of the adsorption unit housing portion 54 to be described later, to correspond to the first external introduction ports 52a. The cold air suction part 52 may have a single first external introduction port 52a and a single first internal communication port 52b.

A cold air suction duct 521 is connected to the first external introduction port 52a, and introduces the cooling air cooled by the evaporator 13. The cold air suction duct 521 connects the first external introduction port 52a of the cold air suction part 52 to the cold air guiding portion 112 of the air-conditioning case 11. The cold air suction duct 521 of this embodiment defines a first introductory part, with the cold air suction part 52, that introduces the cooling air cooled by the evaporator 13 into the adsorption case 51 such that the moisture of air is adsorbed by the adsorption material 61. The cold air suction duct 521 is produced separately from the air-conditioning case 11, and is connected to the cold air guiding portion 112 by a non-illustrated connection component.

The adsorption unit housing portion 54 houses the adsorption unit 60 therein. The adsorption unit housing portion 54 in this embodiment has a hollow cylindrical shape. The adsorption unit housing portion 54 has a housing space 541 for the adsorption unit 60.

The adsorption unit 60 is arranged in the space where the cooling air circulates, in the adsorption unit housing portion 54. The space in the adsorption unit housing portion 54 where the cooling air circulates defines a space in which the moisture in the cooling air adsorbs to the adsorption material 61 of the adsorption unit 60. The details of the adsorption unit 60 and the adsorption material 61 are mentioned later.

The cold air discharge part 56 is communicated to the housing space 541 of the adsorption unit housing portion 54, and air passing through the housing space 541 is discharged to the exterior of the adsorption case 51. A cooling blower 561 is arranged in the cold air discharge part 56 of this embodiment. The cooling blower 561 is disposed to introduce the cooling air from the air-conditioning case 11, where the pressure is low relative to the exterior, into the adsorption case 51. The cooling blower 561 includes a cooling fan 561a and a cooling motor 561b.

The cooling fan 561a draws air from the housing space 541 of the adsorption unit housing portion 54 and discharges the air therefrom. The cooling fan 561a in this embodiment is configured of a centrifugal fan that blows the air drawn thereinto in the axial direction toward the outside thereof in the radial direction. The cooling fan 561a is rotatably driven by the cooling motor 561b. Note that the cooling fan 561a is not limited to the centrifugal fan and may be configured of an axial fan, a cross flow fan, or the like.

Plural cold air discharge ducts 562 and 563 are connected to the cold air discharge part 56 of this embodiment, around the air blow-out side of the cooling fan 561a. Each of the cold air discharge ducts 562 and 563 is a duct which introduces the dehumidification air, from which the moisture is adsorbed by the adsorption material 61 within the adsorption case 51, to a target space for cooling where the in-vehicle heat-emitting apparatus is arranged. Each of the cold air discharge ducts 562 and 563 defines a cooling air outlet part, together with the cold air discharge part 56.

In this embodiment, the cooling device 50 cools a head up display (Head Up Display: HUD) 91 and a meter equipment 92 as the in-vehicle heat-emitting apparatus. A blow-off opening which is a downstream end of the first cold air discharge duct 562 is communicated to a space (namely, the target space for cooling) where the heat-emitting part of HUD 91 which is a heat-emitting apparatus is arranged. Moreover, a blow-off opening which is a downstream end of the second cold air discharge duct 563 is communicated to a space (namely, the target space for cooling) where the heat-emitting part of the meter equipment 92 which is a heat-emitting apparatus is arranged. HUD 91 and the meter equipment 92 correspond to a display which displays information for an occupant.

HUD 91 is a display which displays information on a front field view of the occupant as a virtual image VI. HUD 91 of this embodiment is defined by a windshield display (namely, WSD) using a windshield WS. Specifically, HUD 91 of this embodiment includes a liquid-crystal display unit 912, a plane mirror 913, and a concave mirror 914 in a housing case 911. The liquid-crystal display unit 912 is a display unit which emits the display light (namely, real image) representing information such as a vehicle travelling speed, for an occupant. The plane mirror 913 and the concave mirror 914 are reflectors reflecting the display light (namely, real image) from the liquid-crystal display unit 912 towards the windshield WS through the opening opened in the upper surface of an instrument board. In HUD 91 configured in this way, the windshield WS reflects the light reflected from the concave mirror 914 toward the occupant, such that it is possible to make the occupant to recognize the virtual image VI corresponding to the display light (namely, real image) emitted from the liquid-crystal display unit 912.

The meter equipment 92 is arranged at the front face of the instrument board, and displays vehicle information such as alarm or vehicle speed for the driver. The meter equipment 92 includes a meter panel 921 which defines a frame object, and a display part 922 attached to the meter panel 921 to display information.

Subsequently, the adsorption unit 60 will be described. The adsorption unit 60 has a disk shape that corresponds to the inner shape of the adsorption unit housing portion 54. The adsorption unit 60 is configured to support the adsorption material 61 that adsorbs and desorbs (or releases) moisture into and from the metal plate-shaped members (not shown). The respective plate-shaped members are stacked on each other with a spacing therebetween so as to form a flow path between the adjacent plate-shaped members along the axial direction of the rotary shaft 71 to be described later. The adsorption unit 60 in this embodiment increases a contact area between the ventilation air and the adsorption material 61 by stacking the respective plate-shaped members that support the adsorption material 61.

A polymer adsorbent is adopted as the adsorption material 61. The adsorption material 61 preferably has adsorption property that changes the moisture amount adsorbed (i.e., the adsorption amount) by at least 3 wt % or more when changing the relative humidity of the ventilation air passing through the adsorption unit 60 by 50% within a temperature range expected as a temperature of the ventilation air. More preferably, the adsorption material 61 has the adsorption property that changes the adsorption amount thereof within a range from 3 wt % to 10 wt % under an environment on the same conditions as those described above.

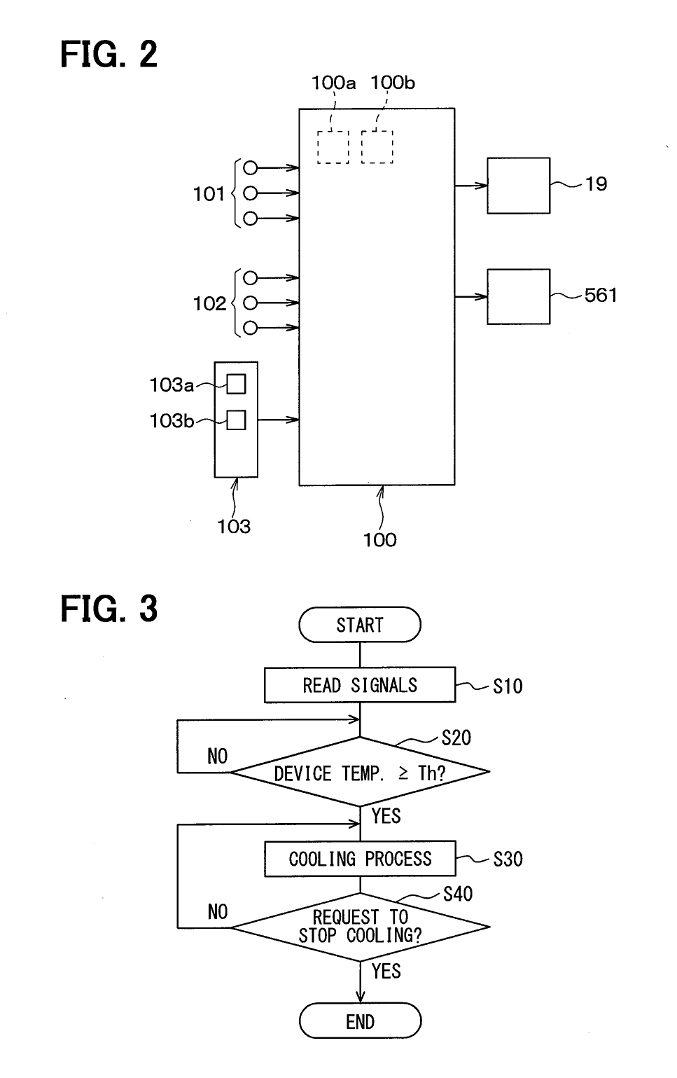

Next, a controller 100 serving as an electric control unit for the vehicle air conditioner will be described with reference to FIG. 2. The controller 100 shown in FIG. 2 is configured of a microcomputer, including storage units, such as a CPU, a ROM, and a RAM, and a peripheral circuit thereof. The controller 100 performs various computations and processing based on control programs stored in the storage unit to thereby control the operations of various devices that are connected to its output side. Note that the storage unit in the controller 100 is configured of a non-transitory tangible storage medium.

The controller 100 in this embodiment is a device obtained by integrally forming a control unit for controlling the operations of respective components of the air-conditioning unit 10 and a control unit for controlling the operations of respective components of the cooling device 50. Alternatively, the controller 100 may have a structure that separately includes the control unit for controlling the operations of respective components of the air-conditioning unit 10 and the control unit for controlling the operations of respective components of the cooling device 50.

The input side of the controller 100 is connected to various sensors 101 for air-conditioning control, various sensors 102 for cooling control, and an operation panel 103 for the air-conditioning control and the cooling control.

The various sensors 101 for the air-conditioning control includes: an inside-air temperature sensor that detects an inside-air temperature; an outside-air temperature sensor that detects an outside-air temperature; a solar radiation sensor that detects the amount of solar radiation in the vehicle interior; and an evaporator temperature sensor that detects the temperature of the evaporator 13.

The various sensors 102 for the cooling control includes a first temperature sensor that detects the temperature of air blown from the cold air discharge part 56, and a second temperature sensor that detects the temperature of the heat-emitting apparatus, such as HUD 91 and the meter equipment 92.

The operation panel 103 has an air-conditioning operation switch 103a, a temperature setting switch 103b, and the like. The air-conditioning operation switch 103a is a switch that switches between on and off of an air-conditioning operation by the air-conditioning unit 10. The temperature setting switch 103b is a switch that presets a target temperature of air blown out of the air-conditioning unit 10.

The controller 100 in this embodiment is a device that integrates therein hardware and software of the control units for controlling the operations of various components connected to its output side. The control units integrated in the controller 100 include an air-conditioning control unit 100a and a cooling control unit 100b. The air-conditioning control unit 100a controls air-conditioning in the vehicle interior by the air-conditioning unit 10. The cooling control unit 100b performs a cooling processing which cools the heat-emitting apparatus using the cooling device 50.

Next, the operations of the air-conditioning unit 10 and the cooling device 50 in this embodiment will be described. First, the outline of the operation of the air-conditioning unit 10 will be described. In the air-conditioning unit 10, when the air-conditioning operation switch 103a is turned on, the controller 100 calculates a target air outlet temperature TAO of the ventilation air to be blown into the vehicle interior, based on detection signals from the respective sensors 101 for the air-conditioning control and the preset temperature set by the temperature setting switch 103b. The controller 100 controls the operations of the respective components in the air-conditioning unit 10 such that the temperature of the ventilation air to be blown into the vehicle interior approaches the target air outlet temperature TAO.

In this way, the controller 100 in the air-conditioning unit 10 controls the respective components according to the detection signals or the like from the respective sensors 101 for the air-conditioning control, thereby making it possible to achieve the appropriate temperature adjustment of the vehicle interior requested by the user.

Subsequently, the operation of the cooling device 50 will be described below with reference to the flowchart of FIG. 3. The controller 100 executes control processing when the air-conditioning operation switch 103a is turned on as shown in the flowchart of FIG. 3.

As shown in FIG. 3, the controller 100 reads the detection signals of the various sensors 102 for the cooling control (S10). The controller 100 determines whether the apparatus temperature of the heat-emitting apparatus which is a detection signal of the second temperature sensor is more than or equal to a predetermined standard threshold temperature Th (S20). The standard threshold temperature is set, for example, near the maximum temperature of a predetermined permissive temperature range for the heat-emitting apparatus.

Here, time may be taken to achieve the cooling effect of the heat-emitting apparatus by the cooling device 50. When such a time delay is taken into consideration, it is desirable to set the standard threshold temperature to be lower than the upper limit temperature of the permissive temperature range of the heat-emitting apparatus, and within a temperature range from a middle temperature (namely, mean value) to the upper limit temperature (namely, maximum) of the permissive temperature range.

When the apparatus temperature of the heat-emitting apparatus is determined to be more than or equal to the standard threshold temperature Th as a result of the determination processing of Step S20, the controller 100 executes the cooling process which cools the heat-emitting apparatus with the cooling device 50 (S30). Specifically, the controller 100 operates the cooling blower 561. In addition, when the air mixing door 18 is at the position to close the warm air passage 16, the controller 100 displaces the air mixing door 18 to a position (for example, intermediate position) to open the warm air passage 16.

At this time, the controller 100 controls the cooling blower 561 such that when the reference air volume is defined as the minimum air volume from the air-conditioning blower 19, the air volume of the cooled air introduced via the cold air suction duct 521 is smaller (for example, at 20 m³/h, which is approximately 20% of the reference air volume) than the reference air volume. In this case, the cooled air introduced via the cold air suction duct 521 is sufficiently smaller than the reference air volume, which hardly affects an air-conditioning function of the air-conditioning unit 10. Note that the controller 100 may be adapted to control the air volume of the cooling blower 561 based on the detection values and the like from the respective sensors 102 for the cooling control.

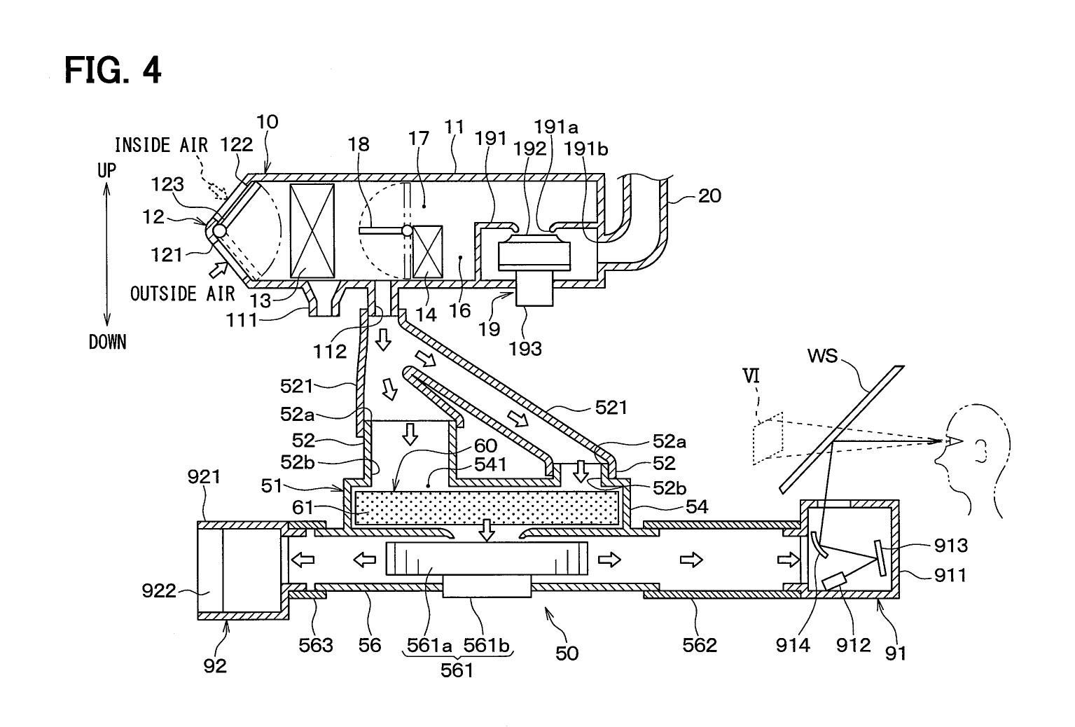

Here, a description will be given on the operating state of the cooling device 50 when the controller 100 executes the cooling process with reference to FIG. 4. As shown in FIG. 4, a part of the low-temperature and high-humidity cooled air (for example, at a temperature of 5° C. and a relative humidity of 100%), cooled by the evaporator 13, is introduced into the adsorption case 51 via the cold air suction duct 521. The moisture contained in the cooled air introduced into the adsorption case 51 is adsorbed into the adsorption material 61 of the adsorption unit 60.

Then, the air which passed through the adsorption unit 60 is blown off to each housing space of HUD 91 and the meter equipment 92 through the cold air discharge part 56 and each of the cold air discharge ducts 562 and 563. Thereby, HUD 91 and the meter equipment 92 can be cooled by the cooling air with low temperature and relatively low humidity.

Returning to FIG. 3, the controller 100 determines whether there is a request to stop cooling (S40) while the cooling process is executed. In the determination processing of Step S40, it is determined that there is no cooling stop request, when the air-conditioning operation switch 103a is ON and the heat-emitting temperature of the heat-emitting component is more than or equal to the lower limit of the permissive temperature range. In the determination processing of Step S40, it is determined that there is a cooling stop request, when the air-conditioning operation switch 103a is OFF or when the heat-emitting temperature of the heat-emitting component is less than the lower limit of the permissive temperature range. In addition, the determination processing of Step S40 may be performed based on signals (for example, stop request signal coming from an external system) other than the air-conditioning operation switch 103a and the heat-emitting temperature of the heat-emitting component.

As a result of the determination processing of Step S40, when it is determined that there is no cooling stop request, the controller 100 continues the cooling process. When it is determined that there is a cooling stop request, the operation of the various apparatus of the cooling device 50 is suspended to end the cooling process.

According to the cooling device 50 and the air-conditioner for a vehicle of this embodiment, the low-humidity cold air cooled with the evaporator 13 of the air-conditioning unit 10 and dehumidified by the adsorption material 61 of the adsorption unit 60 can be introduced into the target space for cooling where the in-vehicle heat-emitting apparatus is arranged. For this reason, compared with a case where high-humidity and low-temperature air cooled with the evaporator 13 is introduced to the target space as it is, dew condensation can be suppressed on and around the heat-emitting apparatus.

Therefore, the cooling device 50 and the air-conditioner of this embodiment can restrict the dew condensation while the in-vehicle heat-emitting apparatus is cooled.

It is not desirable that dew condensation arises to an equipment which displays information for an occupant because not only causing electric abnormalities in the display device, but affecting the display function of the display device. For example, if fogging occurs on a part of the reflecting mirror by the dew condensation, HUD 91 may not able to display exact information in the front view of an occupant. Moreover, if fogging occurs on a part of the display part 922 by the dew condensation, the meter equipment 92 may not able to display exact information on the display part 922.

In contrast, according to this embodiment, since HUD 91 and the meter equipment 92 are cooled by the dehumidification air with the relatively low humidity, compared with the cooling air cooled with the evaporator 13, electric abnormalities can be restricted from being generated in each of the display devices, such that it becomes possible to offer accurate information required by an occupant.

The cooling device 50 is not limited to be arranged at the lower side of the air-conditioning unit 10, as described in this embodiment. For example, the cooling device 50 may be arranged at the upper side or the lateral side of the air-conditioning unit 10. This can be applied to the subsequent embodiments similarly.

### Second Embodiment

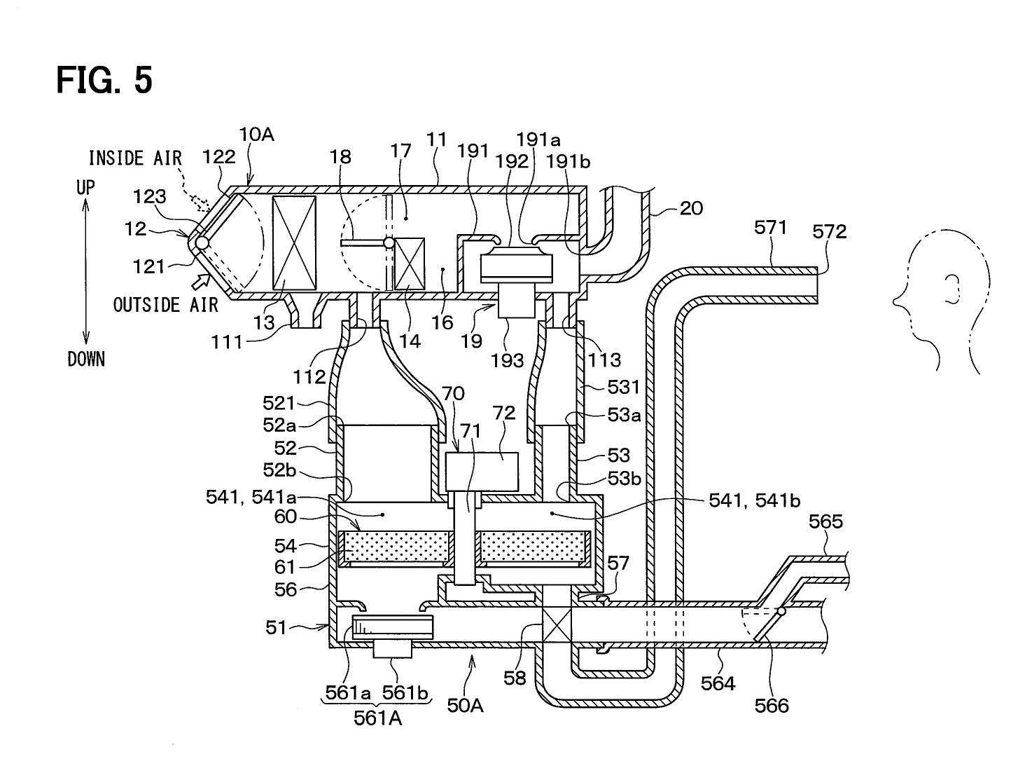

Next, a second embodiment is described with reference to FIG. 5 to FIG. 12. This embodiment is different from the first embodiment at a point where a humidification function is added to the cooling device 50A. Portions same or equivalent to the first embodiment are omitted or simplified in the explanation.

The air-conditioning unit 10A of this embodiment is explained with reference to FIG. 5. As shown in FIG. 5, the air-conditioning unit 10A of this embodiment has a warm air outlet part 113 through which the air heated by the heater core 14 is introduced from the air-conditioning case 11 to the exterior.

The warm air outlet part 113 is an opening defined in the air-conditioning case 11 to guide a part of the air heated with the heater core 14 to the exterior of the air-conditioning case 11. The warm air outlet part 113 of this embodiment is formed in the bottom part of the air-conditioning case 11 at a position between the air-conditioning fan 192 of the air-conditioning blower 19 and the discharge port 191b. The warm air outlet part 113 of this embodiment is formed at a position downstream of the air-conditioning blower 19 in the air flow, for example, may be formed in the air-conditioning duct 20 of the air-conditioning case 11.

Then, the cooling device 50A of this embodiment is explained. As shown in FIG. 5 to FIG. 7, the adsorption case 51 of the cooling device 50A of this embodiment has a warm air suction part 53 and a warm air discharge part 57.

The warm air suction part 53 has a second external feed port 53a communicated to the outside, and a second internal communication port 53b communicated to a moisture-desorbing space 541b of the adsorption unit housing portion 54 to be mentioned later. The second external feed port 53a is connected to the warm air suction duct 531 which introduces air (may be referred to the low humidity air) with relatively low humidity and temperature higher than the temperature of the air cooled with the evaporator 13.

The warm air suction duct 531 is configured to introduce the heating air heated with the heater core 14 as the low humidity air. That is, one end of the warm air suction duct 531 is connected to the second external feed port 53a of the warm air suction part 53, and the other end is connected to the warm air outlet part 113 of the air-conditioning unit 10A.

Together with the warm air suction part 53, the warm air suction duct 531 in this embodiment configures a second introductory part that introduces the low humidity air into the adsorption case 51, as air that causes moisture to be desorbed from the adsorption material 61. The warm air suction duct 531 is a component produced separately from the air-conditioning case 11.

The warm air suction duct 531 in this embodiment has its size set such that when a reference air volume is defined as a minimum air volume from the air-conditioning blower 19, the air volume of the heated air introduced via the warm air suction duct 531 is smaller (for example, at 10 m³/h, which is approximately 10% of the reference air volume) than the reference air volume.

The adsorption unit housing portion 54 has, as the housing space 541, a space for the cooled air introduced via the cold air suction part 52 and a space for the heated air introduced via the warm air suction part 53.

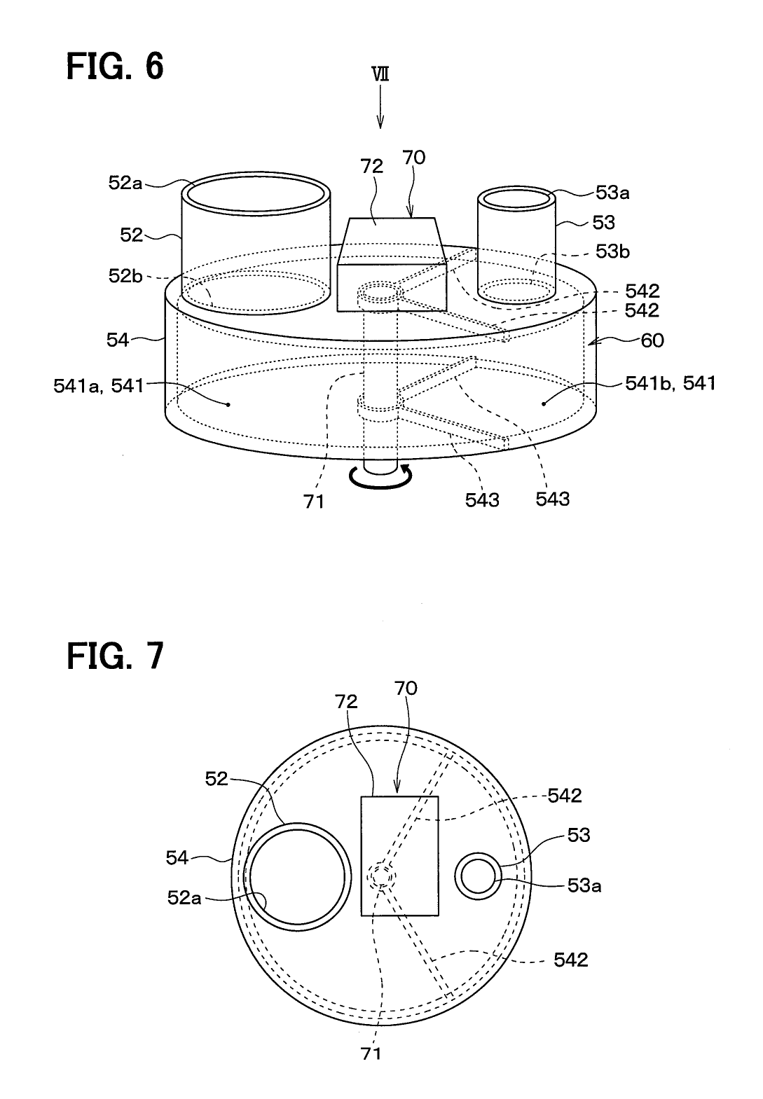

Specifically, as shown in FIG. 6, the housing space 541 is partitioned into the space for the cooled air and the space for the heated air by first and second partition members 542 and 543 that are provided respectively upstream and downstream of the adsorption unit 60 in the air flow.

The first partition member 542 is a member on the air-flow upstream side of the adsorption unit 60 and partitions the space on the air-flow upstream side of the adsorption unit 60 into a flow path for the cooled air and a flow path for the heated air. The first partition member 542 is integrally formed with the inner side of an upper surface part of the adsorption unit housing portion 54.

The second partition member 543 is a member on the air-flow downstream side of the adsorption unit 60 and partitions the space on the air-flow downstream side of the adsorption unit 60 into the flow path for the cooled air and the flow path for the heated air. The second partition member 543 is integrally formed with the inner side of a bottom surface part of the adsorption unit housing portion 54.

In the adsorption unit housing portion 54, the adsorption unit 60 is disposed to stride across both the space for circulation of the cooled air and the space for circulation of the heated air. The space for the cooled air in the adsorption unit housing portion 54 configures the moisture-adsorption space 541a that allows moisture contained in the cooled air to be adsorbed in the adsorption material 61 of the adsorption unit 60. The space for the heated air in the adsorption unit housing portion 54 configures the moisture-desorption space 541b that desorbs moisture adsorbed in the adsorption material 61 of the adsorption unit 60 therefrom and humidifies the heated air with the moisture.

Here, an adsorption rate of moisture per unit mass into the adsorption material 61 tends to be approximately twice as slow as a desorption rate of moisture per unit mass from the adsorption material 61. As the amount of the moisture adsorbed into the adsorption material 61 decreases, it might be difficult for the cooling device 50A to sufficiently ensure the dehumidification effect.

When taking this into account, in this embodiment, the housing space 541 of the adsorption unit 60 is partitioned by the respective partition members 542 and 543 such that the amount of the adsorption material 61 existing in the moisture-adsorption space 541a is more than that of the adsorbent existing in the moisture-desorption space 541b. Specifically, a member bent in a L shape is used as each of the partition members 542 and 543, and thereby the moisture-adsorption space 541a is set approximately twice as large as the moisture-desorption space 541b in the housing space 541 of the adsorption unit 60.

Returning to FIG. 5, the cold air discharge part 56 is communicated with the moisture-adsorption space 541a of the adsorption unit housing portion 54 and discharges the air passing through the moisture-adsorption space 541a to the outside of the adsorption case 51. The cooling blower 561A is arranged at the cold air discharge part 56 to introduce cooling air into the adsorption case 51 from the inside of the air-conditioning case 11 where the pressure is low relative to the exterior. The cooling blower 561 includes the cooling fan 561a and the cooling motor 561b. The cooling fan 561a draws the air from the moisture-adsorbing space 541a of the adsorption unit housing portion 54 and discharges. The cooling fan 561a is rotated by the cooling motor 561b.

The cold air discharge part 56 of this embodiment is connected to the first cold air discharge duct 564 and the second cold air discharge duct 565. The first cold air discharge duct 564 is a duct which introduces the dehumidification air from which the moisture is adsorbed by the adsorption material 61 existing in the moisture-adsorbing space 541a of the adsorption case 51 into the space for cooling where the in-vehicle heat-emitting apparatus is arranged. The first cold air discharge duct 564 constitutes the cooling air outlet part with the cold air discharge part 56.

The second cold air discharge duct 565 is a duct which introduces the dehumidification air from which the moisture is adsorbed by the adsorption material 61 existing in the moisture-adsorbing space 541a of the adsorption case 51 to the space (for example, the lower side space of the vehicle interior) different from the target space for cooling in the vehicle interior. The second cold air discharge duct 565 configures a dehumidification air outlet part.

The second cold air discharge duct 565 of this embodiment is connected to the cold air discharge part 56 through the first cold air discharge duct 564. In addition, the second cold air discharge duct 565 may be directly connected to the cold air discharge part 56 without through the first cold air discharge duct 564.

Moreover, a passage change door 566 is arranged at a connection area (namely, branch part) of the cold air discharge ducts 564 and 565 of this embodiment as a passage change part which changes the outlet passage of dehumidification air between the first cold air discharge duct 564 and the second cold air discharge duct 565. The passage change door 566 is rotatably arranged at the branch part of the cold air discharge ducts 564 and 565. The passage change door 566 is driven by an actuator which is not illustrated.

The warm air discharge part 57 is communicated with the moisture-desorption space 541b of the adsorption case 51 and discharges the air passing through the moisture-desorption space 541b to the outside of the adsorption case 51. The warm air discharge part 57 in this embodiment is connected to a humidification duct 571.

The humidification duct 571 is a duct that guides the humidification air, humidified in the moisture-desorption space 541b of the adsorption case 51, into the vehicle interior. The humidification duct 571 configures a cabin outlet part, together with the warm air discharge part 57. The humidification duct 571 in this embodiment is a component separately formed from the air-conditioning duct 20, which is an outlet duct in the air-conditioning unit 10.

The humidification duct 571 has an outlet opening 572 as its downstream end that is opened at a part (for example, a meter hood) located at the dashboard and near an occupant's face. The outlet opening 572 is opened in a position different from the outlet portion of the air-conditioning unit 10, and from the opening of the second cold air discharge duct 565 adjacent to the vehicle interior. Thus, the air flowing through the humidification duct is blown toward the occupant's face, thereby humidifying a space around the occupant's face.

In this embodiment, a duct having a flow-path diameter of φ50 mm and a flow-path length of approximately 1000 mm is adopted as the humidification duct 571. Thus, the high-temperature and high-humidity humidification air passing through the adsorption unit 60 is cooled by exchanging heat with air outside the humidification duct 571, thereby making it possible to increase the relative humidity of the humidification air.

Regarding the outlet opening 572 of the humidification duct 571, its opening area is set to be larger than a flow-path cross section of the flow path leading to the outlet opening 572 such that the blown air therefrom reaches the face in a high-humidity state. In the humidification duct 571 configured in this way, the air speed reaching the occupant becomes low, so that the diffusion of the humidification air can be suppressed, thereby surely causing the humidification air to reach the face.

Furthermore, the humidification duct 571 in this embodiment is configured to be thinner than the cold air suction duct 521 and the warm air suction duct 531 in such a manner as to exchange heat between the air circulating through the duct 571 and the air existing outside the duct 571.

Here, an air-air heat exchanger 58 is disposed in the cold air discharge part 56 and the warm air discharge part 57 in this embodiment. The air-air heat exchanger 58 exchanges heat between the air (i.e., cold air) passing through the moisture-adsorption space 541a of the adsorption unit housing portion 54 and the air (i.e., hot air) passing through the moisture-desorption space 541b.

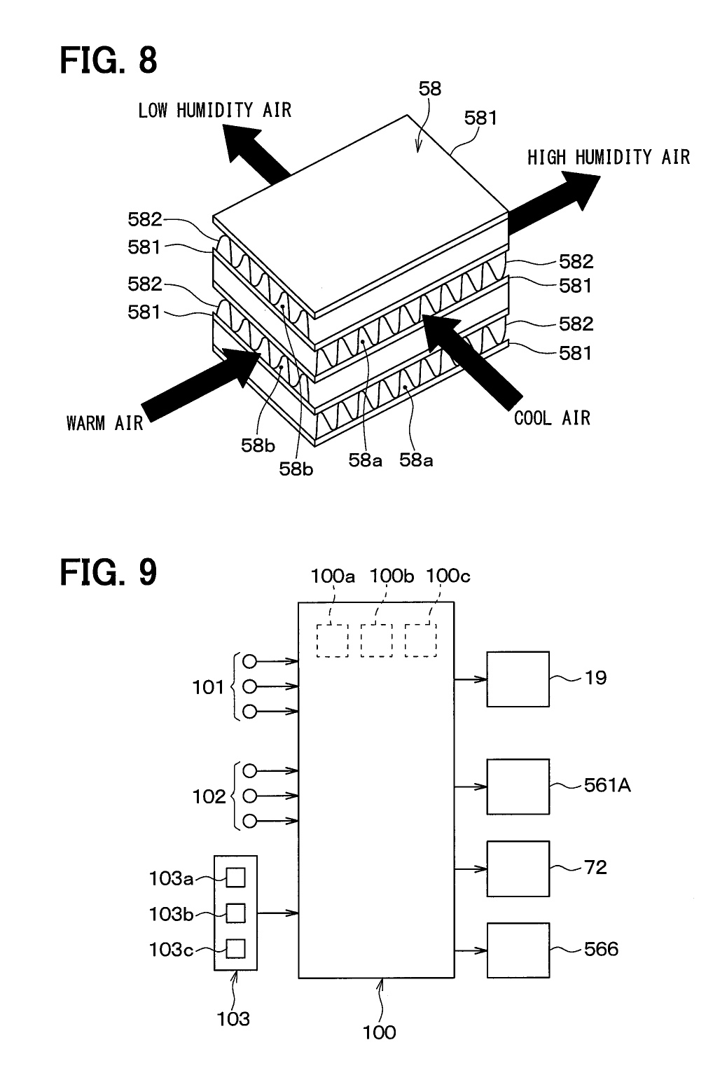

As shown in FIG. 8, the air-air heat exchanger 58 is a heat exchanger that includes a plurality of metal plate-shaped members 581 and fins 582 disposed between the adjacent plate-shaped members 581. The air-air heat exchanger 58 in this embodiment independently forms flow paths 58a for circulation of the cold air and flow paths 58b for circulation of the hot air so as not to mix the cold air and hot air therein. Note that materials for use in the plate-shaped members 581 and the fins 582 are desirably formed of metal with excellent heat conductivity (e.g., aluminum, or copper).

Subsequently, the adsorption unit 60 will be described with reference to FIGS. 6 and 7. As shown in FIGS. 6 and 7, the adsorption unit 60 has its center part coupled to a rotary shaft 71 of a drive component 70 to be described later. The adsorption unit 60 is rotatably supported by the adsorption case 51 via the rotary shaft 71.

The adsorption unit 60 in this embodiment is received in the adsorption unit housing portion 54 that has its internal space partitioned into the moisture-adsorption space 541a and the moisture-desorption space 541b. Although the adsorption unit 60 is disposed to stride across both the moisture-adsorption space 541a and the moisture-desorption space 541b as mentioned above, there is a limitation on the adsorption amount of moisture that can be adsorbed in the adsorption material 61 existing in the moisture-adsorption space. Further, there is also a limitation on the amount of moisture desorbed by the adsorption material 61 existing in the moisture-desorption space 541b.

The cooling device 50A includes the drive component 70 that serves as a shift mechanism for moving the adsorption material 61 of the adsorption unit 60 between the moisture-adsorption space 541a and the moisture-desorption space 541b. The drive component 70 is a device that moves at least a part of the adsorption material 61 existing in the moisture-adsorption space 541a of the adsorption unit 60 to the moisture-desorption space 541b, while moving at least a part of the adsorption material 61 existing in the moisture-desorption space 541b of the adsorption unit 60 to the moisture-adsorption space 541a.

The drive component 70 is configured to include the rotary shaft 71 and an electric motor 72 with a decelerator. The rotary shaft 71 is coupled to the adsorption unit 60, while penetrating the center of the adsorption unit 60. The electric motor 72 serves to rotatably drive the rotary shaft 71. The rotary shaft 71 is rotatably supported by the adsorption case 51. The rotary shaft 71 rotates together with the adsorption unit 60 within the adsorption case 51 when receiving a driving force transferred thereto from the electric motor 72. Thus, a part of the adsorption material 61 existing in the moisture-desorption space 541b of the adsorption unit 60 moves to the moisture-adsorption space 541a, while a part of the adsorption material 61 existing in the moisture-adsorption space 541a of the adsorption unit 60 moves to the moisture-desorption space 541b.

The electric motor 72 in this embodiment serves to rotatably drive the rotary shaft 71 continuously in one direction. Thus, the adsorption material 61 that has sufficiently desorbed moisture at the moisture-desorption space 541b in the adsorption unit 60 can be moved to the moisture-adsorption space 541a, while the adsorption material 61 that has sufficiently adsorbed moisture at the moisture-adsorption space 541a in the adsorption unit 60 can be moved to the moisture-desorption space 541b.

Then, the controller 100 of this embodiment is explained with reference to FIG. 9. As shown in FIG. 9, the controller 100 of this embodiment is connected with the operation panel 103 having an air-conditioning operation switch 103a, a temperature setting switch 103b, and a humidification operation switch 103c, at the input side. The humidification operation switch 103c is a switch that switches between on and off of a humidification operation using the cooling device 50A.

The control units integrated in the controller 100 include a humidification control unit 100c which performs humidifying process which humidifies the vehicle interior using the cooling device 50A, other than the air-conditioning control unit 100a and the cooling control unit 100b.

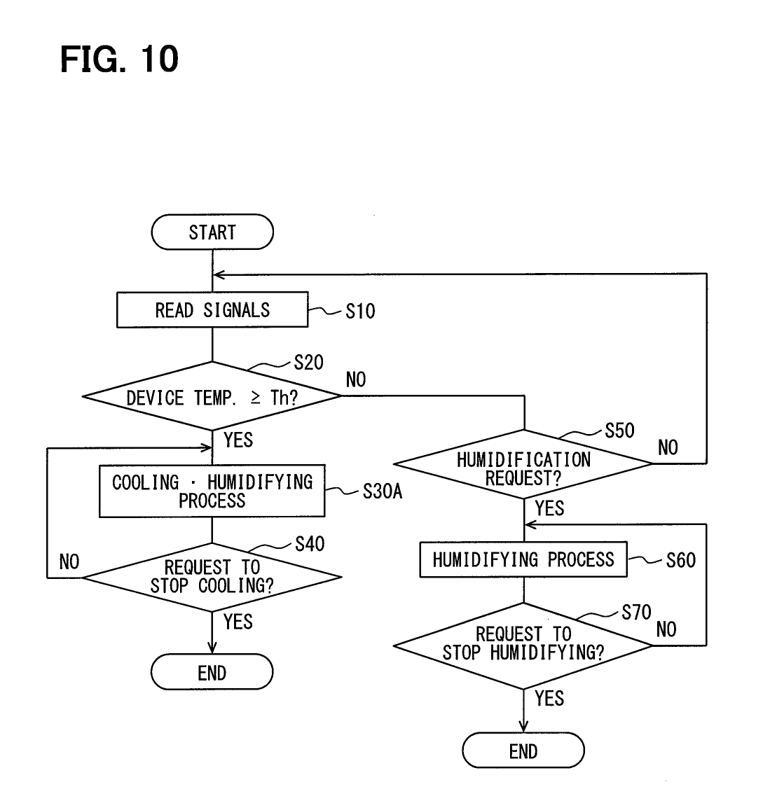

Next, the operation of the cooling device 50A of this embodiment is explained using the flow chart shown in FIG. 10. The controller 100 will perform control processing shown in the flow chart of FIG. 10, if the air-conditioning operation switch 103a is turned on.

As shown in FIG. 10, the controller 100 reads the detection signal of the various sensors 102 for the cooling control (S10), and determines whether the temperature of the heat-emitting apparatus is more than or equal to a standard threshold temperature Th (S20).

When the temperature of the heat-emitting apparatus is determined to be more than or equal to the standard threshold temperature Th as a result of the determination processing of Step S20, the controller 100 executes a cooling and humidifying process, using the cooling device 50A, to cool the heat-emitting apparatus and to humidify the vehicle interior (530A).

Specifically, the controller 100 controls the actuator of the passage change door 566 so that the outlet passage of dehumidification air is set to the first cold air discharge duct 564. Thereby, the passage change door 566 is displaced to the position opening the passage in the first cold air discharge duct 564 and closing the passage in the second cold air discharge duct 565.

In this state, the controller 100 makes the cooling blower 561 to operate, and operates the drive component 70 to rotate the adsorption unit 60 at a predetermined revolving speed (for example, 5 rpm). In addition, when the air mixing door 18 is at the position to close the warm air passage 16, the controller 100 displaces the air mixing door 18 to the position (for example, intermediate position) for opening the warm air passage 16.

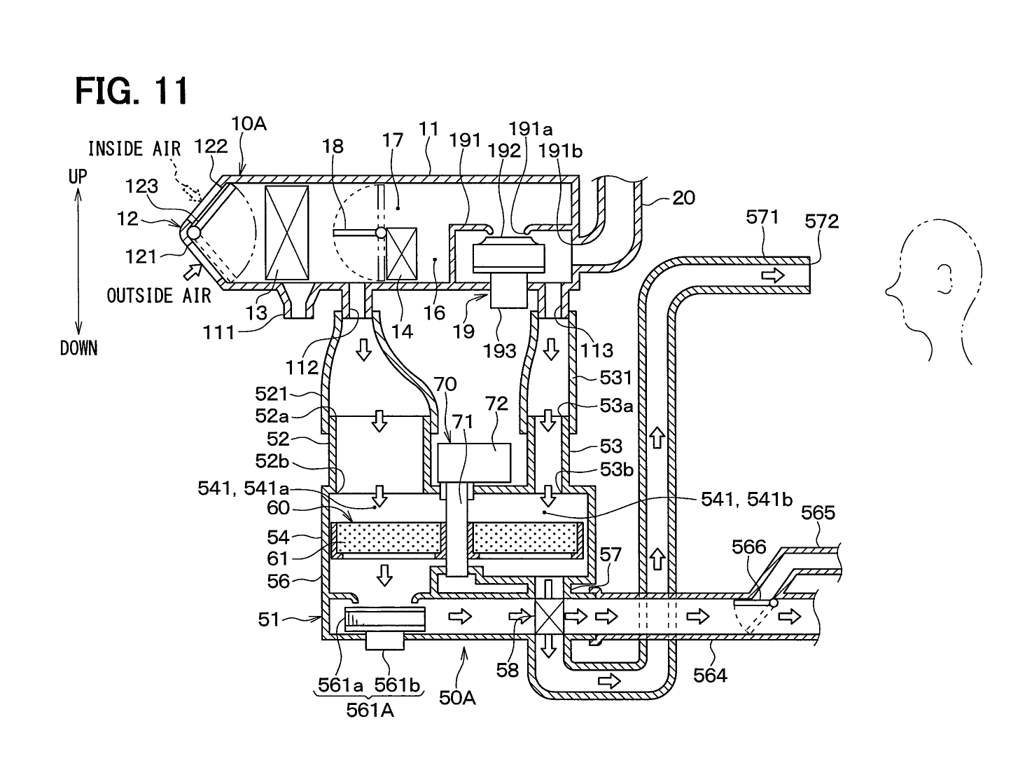

Here, the operational status of the cooling device 50A at the time when the controller 100 execute the cooling and humidifying process is explained using FIG. 11. As shown in FIG. 11, a part of the low-temperature and high-humidity cooling air (for example, temperature of 5° C., relative humidity of 100%) cooled with the evaporator 13 is introduced in the adsorption case 51 through the cold air suction duct 521. The moisture contained in the cooling air introduced into the adsorption case 51 is adsorbed by the adsorption material 61 in the moisture-adsorbing space 541a in the adsorption unit 60.

At this time, since the adsorption unit 60 rotates in the housing space 541, the adsorption material 61 from which the moisture is fully removed in the moisture-desorbing space 541b in the adsorption unit 60 is moved to the moisture-adsorbing space 541a. Therefore, the moisture contained in the cooling air introduced into the adsorption case 51 can continuously adsorbed by the adsorption material 61 existing in the moisture-adsorbing space 541a in the adsorption unit 60.

Then, the dehumidification air which passed through the moisture-adsorbing space 541a flows through the cold air discharge part 56. The temperature of the dehumidification air which flows through the cold air discharge part 56 is raised by heat exchange with the high-temperature and low-humidity air which flows through the warm air discharge part 57 in the air-air heat exchanger 58, and the relative humidity is further lowered. The dehumidification air which passed the air-air heat exchanger 58 blows off to the housing space of heat-emitting apparatus through the first cold air discharge duct 564. Thereby, the heat-emitting apparatus is cooled by the cold air with low-temperature and relatively low humidity.

Moreover, a part of the high-temperature and low-humidity air heated with the heater core 14 (for example, temperature of 25° C., relative humidity of 20%) is introduced in the adsorption case 51 through the warm air suction duct 531. The low-humidity air introduced into the adsorption case 51 is humidified (for example, temperature of 21° C., relative humidity of 57%) because the moisture of the adsorption material 61 of the adsorption unit 60 existing in the moisture-desorbing space 541b is desorbed.

At this time, since the adsorption unit 60 rotates in the housing space 541, the adsorption material 61 which fully adsorbs moisture in the moisture-adsorbing space 541a in the adsorption unit 60 moves to the moisture-desorbing space 541b. Thereby, the heating air introduced into the adsorption case 51 is continuously humidified by moisture of the adsorption material 61 existing in the moisture-adsorbing space 541a, in the adsorption unit 60.

In this embodiment, the warm air suction duct 531 is connected to the air discharge side of the air-conditioning blower 19 where the pressure becomes higher than the pressure within the adsorption case 51. For this reason, the low humidity air heated with the heater core 14 is introduced in the adsorption case 51 through the warm air suction duct 531 due to the pressure difference between the air discharge side of the air-conditioning blower 19 and the inside of the adsorption case 51.

Then, the humidification air humidified in the moisture-desorbing space 541b flows through the warm air discharge part 57. The humidification air which flows through the warm air discharge part 57 is cooled by heat exchange with the cooling air which flows through the cold air discharge part 56 in the air-air heat exchanger 58. As the result, the temperature is lowered, and the relative humidity is raised (for example, temperature of 18° C., relative humidity of 65%). The humidification air which passed the air-air heat exchanger 58 blows off from the outlet opening 572 towards a face of an occupant through the humidification duct 571.

Returning to FIG. 10, the controller 100 determines whether there is a request to stop cooling while the cooling and humidifying process is performed (S40). The controller 100 continues the cooling and humidifying process, when it is determined that there is no cooling stop request, as a result of determination processing of Step S40. When it is determined that there is a cooling stop request, the cooling and humidifying process is finished by stopping the operation of the various apparatus of the cooling device 50A.

When it is determined that the apparatus temperature of the heat-emitting apparatus is less than the standard threshold temperature Th as a result of the determination processing of Step S20, it is determined whether there is a humidification request by detecting on/off of the humidification operation switch 103c (S50). In the determination processing of Step S50, when the humidification operation switch 103c is off, it is determined that there is no humidification request. When the humidification operation switch 103c is on, it is determined that there is a humidification request.

When it is determined that there is a humidification request as a result of determination processing of Step S50, a humidifying process is performed to humidify the vehicle interior in the state where the cooling of heat-emitting apparatus is stopped (S60). Specifically, the controller 100 controls the actuator of the passage change door 566 to switch the outlet passage of dehumidification air to the second cold air discharge duct 565. Thereby, the passage change door 566 is displaced to the position closing the passage in the first cold air discharge duct 564 and opening the passage in the second cold air discharge duct 565.

The controller 100 makes the cooling blower 561 to operate, and operates the drive component 70 to rotate the adsorption unit 60 with a predetermined revolving speed in this state. In addition, when the air mixing door 18 is at the position closing the warm air passage 16, the controller 100 displaces the air mixing door 18 to the position opening the warm air passage 16.

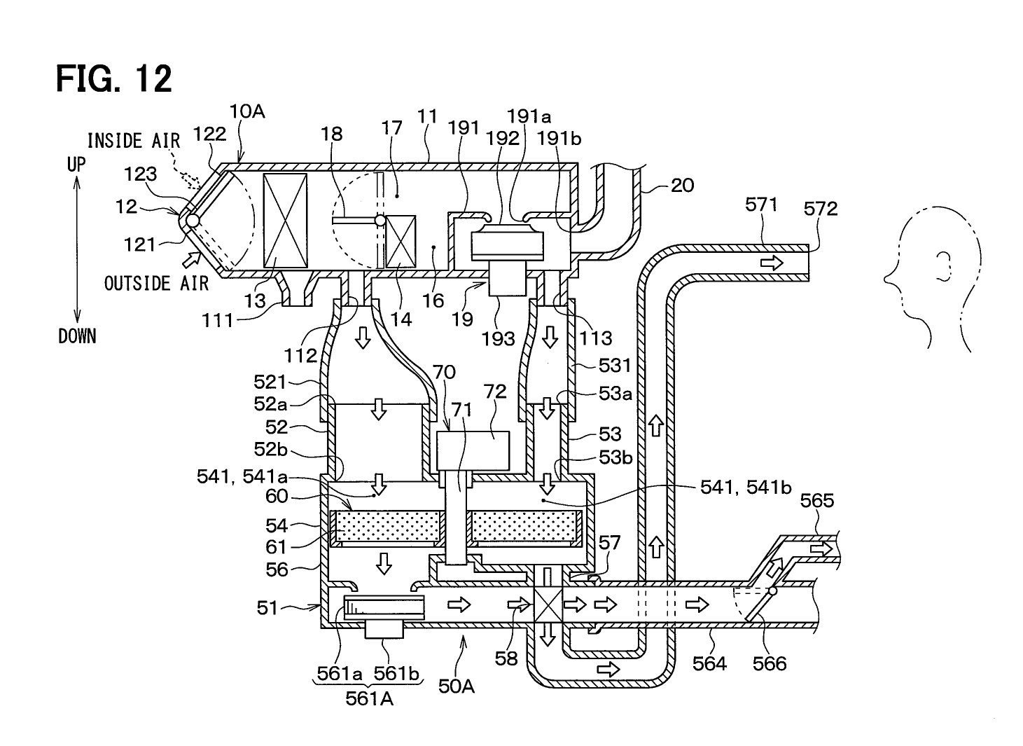

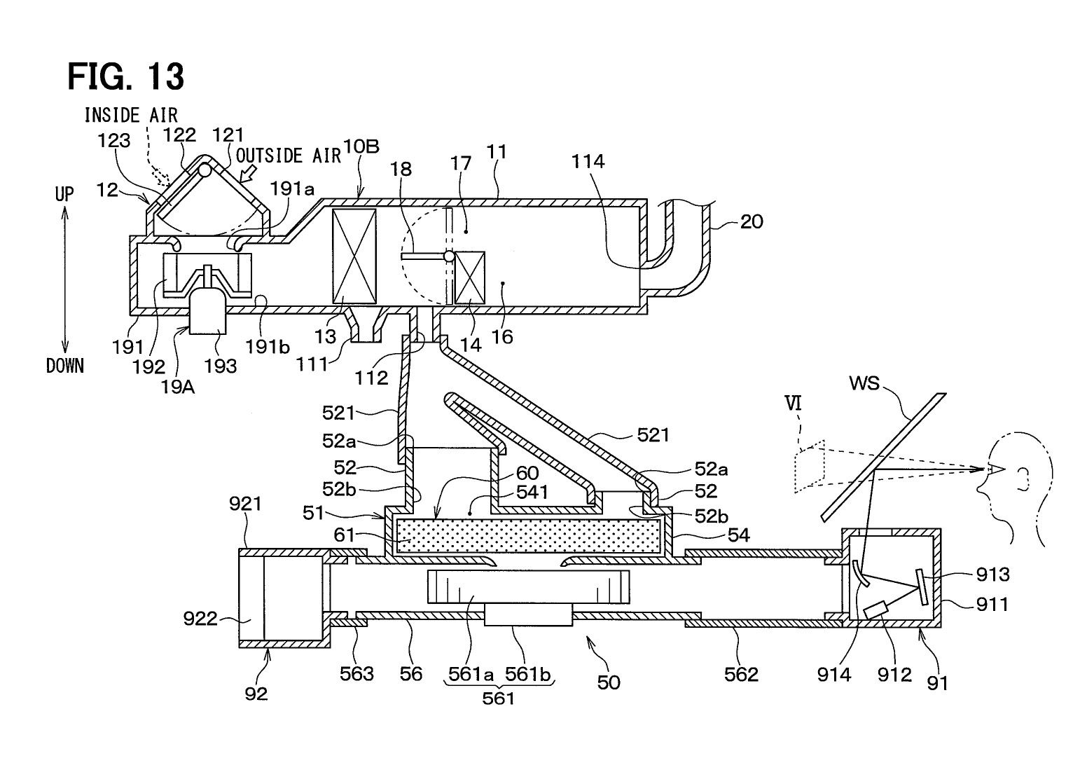

Here, the operational status of the cooling device 50A at the time when the controller 100 performs the humidifying process is explained using FIG. 12. As shown in FIG. 12, a part of the cooling air with low-temperature and high-humidity cooled with the evaporator 13 is introduced in the adsorption case 51 through the cold air suction duct 521. The cooling air introduced into the adsorption case 51 is dehumidified by the adsorption material 61 in the moisture-adsorbing space 541a in the adsorption unit 60. At this time, since the adsorption unit 60 rotates in the housing space 541, the adsorption material 61 from which the moisture is fully removed in the moisture-desorbing space 541b in the adsorption unit 60 moves to the moisture-adsorbing space 541a.

Then, the dehumidification air which passed through the moisture-adsorbing space 541a flows through the cold air discharge part 56. The dehumidification air which flows through the cold air discharge part 56 is blown off to the vehicle interior through the second cold air discharge duct 565, after passing the air-air heat exchanger 58. Since the flow of the air introduced in the adsorption case 51 through the warm air suction duct 531 is the same as that of the cooling and humidifying process (processing of Step S30A), its explanation is omitted.

Returning to FIG. 10, the controller 100 determines whether there is a request to stop the humidifying while the humidifying process is executed (S70). In the determination processing of Step S70, when both of the operation switches 103a and 103c are on, it is determined that there is no humidification stop request. When one of the operation switches 103a and 103c is off, it is determined that there is a humidification stop request.

As a result of determination processing of Step S70, the controller 100 continues the humidifying process, when it is determined that there is no humidification stop request. When it is determined that there is a humidification stop request, the operation of the various apparatus of the cooling device 50A is stopped to end the humidifying process.

When it is determined that there is a humidification stop request, the controller 100 may execute a desorption process to desorb the moisture from the adsorption material 61 of the adsorption unit 60. Specifically, at the time of executing the desorption process, the controller 100 stops operation of the cooling blower 561 in the state where the adsorption unit 60 is rotated by the drive component 70. According to this, adsorption of moisture in the adsorption material 61 in the moisture-adsorbing space 541a is stopped, and the moisture desorption of the adsorption material 61 in the moisture-adsorbing space 541a is continued, such that the moisture can be desorbed from the adsorption material 61. In addition, it is desirable to continue the desorption process, until a predetermined processing continuation time passes after it is determined that there is a humidification stop request. The processing continuation time may be set as a time period taken for desorbing all the moisture adsorbed by the adsorption material 61 existing in the moisture-desorbing space 541b with the cooling device 50A.

According to the cooling device 50A and the air-conditioner for a vehicle equipped with the cooling device 50A of this embodiment, the low-humidity cooled air dehumidified by the adsorption material 61 of the adsorption unit 60 is introduced into the space for cooling where the in-vehicle heat-emitting apparatus is arranged. For this reason, it becomes possible to restrict dew condensation from being generated while the in-vehicle heat-emitting apparatus is cooled.

The cooling device 50A of this embodiment is configured to humidify the vehicle interior using moisture of the cooling air cooled in the air-conditioning unit 10. Therefore, it is possible to humidify the vehicle interior without supplying water from the outside.

Moreover, the cooling device 50A of this embodiment includes the drive component 70 which moves a part of the adsorption material 61 in the moisture-adsorbing space 541a to the moisture-desorbing space 541b and which moves a part of the adsorption material 61 in the moisture-desorbing space 541b to the moisture-adsorbing space 541a.

Thus, the heating air can be humidified by the moisture desorbed from the adsorption material 61 in the moisture-desorbing space 541b, which was absorbed in the moisture-adsorbing space 541a, and moisture of the cooling air which circulates the moisture-adsorbing space 541a can be adsorbed by the adsorption material 61 from which the moisture was desorbed in the moisture-desorbing space 541b.

In this embodiment, the air-air heat exchanger 58 is arranged to exchange heat between the cooling air which passed through the moisture-adsorbing space 541a, and the humidification air which passed through the moisture-desorbing space 541b. Since the temperature of air which passed through the moisture-adsorbing space 541a is raised by the air which passed through the moisture-desorbing space 541b, the air-air heat exchanger 58 can lower the relative humidity of the air which cools heat-emitting apparatus. As a result, it becomes possible to sufficiently restrict dew condensation of the heat-emitting apparatus.

In contrast, since the air which passed through the moisture-desorbing space 541b can be cooled by the air (namely, cooling air) which passed through the moisture-adsorbing space 541a, the air-air heat exchanger 58 can raise the relative humidity of the humidification air introduced to the vehicle interior. This becomes possible to improve the comfortableness for an occupant by humidifying the vehicle interior.

Meanwhile, if the dehumidification air continues to cool the heat-emitting apparatus, the temperature of the apparatus may decrease too much and the operation may become unstable. That is, the function may be influenced, depending on the heat-emitting apparatus, by cooling too much.

In view of this point, the cooling device 50A of this embodiment includes the passage change door 566 which changes the outlet passage of dehumidification air to either the first cold air discharge duct 564 or the second cold air discharge duct 565. According to this, the heat-emitting apparatus can be cooled with the low-humidity and low-temperature air, if needed. In addition, the passage change part such as the passage change door 566 is applicable also to the first embodiment and the subsequent embodiment.

The warm air suction duct 531 is not limited to be connected to the warm air outlet part 113 of the air-conditioning unit 10A, such that the low humidity air heated with the heater core 14 is introduced to the adsorption case 51, like this embodiment. For example, the warm air suction duct 531 may be connected with a non-illustrated opening formed in the vehicle interior, and air may be introduced from the vehicle interior into the adsorption case 51 as the low humidity air.

In this embodiment, heat is exchanged between the air which passed through the moisture-adsorbing space 541a, and the air which passed through the moisture-desorbing space 541b in the air-air heat exchanger 58, but is not limited to this. That is, the other component other than the heat exchanger may be adopted to transfer heat between the air which passed through the moisture-adsorbing space 541a, and the air which passed through the moisture-desorbing space 541b, as a heat exchange part.

### Third Embodiment

A third embodiment is described with reference to FIG. 13. This embodiment is different from the first embodiment in that the cooling device 50 is applied to an air-conditioning unit 10B in which an air-conditioning blower 19A is arranged upstream of the evaporator 13 in the air flow.

As shown in FIG. 13, in the air-conditioning unit 10B of this embodiment, the air-conditioning blower 19A is arranged downstream of the inside/outside air switch box 12 in the air flow, and is arranged upstream of the evaporator 13 in the air flow. The air-conditioning blower 19A of this embodiment has a suction port 191a opened toward the inside/outside air switch box 12, and a discharge port 191b opened toward the evaporator 13.

Moreover, the air-conditioning case 11 of this embodiment has an opening 114 for blowing off the air with the controlled temperature from the air-conditioning case 11 to the vehicle interior through the air-conditioning duct 20 and the blow-off part, at the downstream side of the heater core 14 in the air flow.

The air-conditioning unit 10B of this embodiment is a pushing type unit in which the air-conditioning blower 19A is arranged upstream of the evaporator 13 in the air flow. For this reason, the pressure downstream of the air discharge side of the air-conditioning blower 19A inside of the air-conditioning case 11 is higher than the pressure out of the air-conditioning case 11.

The other configuration is the same as that of the first embodiment. According to this embodiment, the low-humidity cooling air dehumidified by the adsorption material 61 of the adsorption unit 60 is introduced into the space for cooling where the in-vehicle heat-emitting apparatus is arranged. For this reason, it becomes possible to restrict dew condensation from being generated while the in-vehicle heat-emitting apparatus is cooled.

Here, as mentioned above, the air-conditioning unit 10B of this embodiment is a pushing type unit, and the pressure adjacent to the evaporator 13 in the air-conditioning case 11 becomes higher than the pressure within the adsorption case 51. For this reason, a part of the cooling air cooled with the evaporator 13 is introduced into the adsorption case 51 through the cold air suction duct 521 due to the pressure difference between the air discharge side of the air-conditioning blower 19, and the inside of the adsorption case 51.

Thus, in this embodiment, the cooling air is introduced into the adsorption case 51 through each of the suction ducts 521 and 531 due to the pressure difference between the air discharge side of the air-conditioning blower 19, and the inside of the adsorption case 51. For this reason, according to the present embodiment, compared with the first embodiment, energy required for operating the cooling blower 561 can be reduced as an advantage. In addition, the cooling blower 561 may be omitted from the cooling device 50 if the introduction amount of the cooling air to the adsorption case 51 can be sufficiently secured by the pressure difference between the air discharge side of the air-conditioning blower 19, and the inside of the adsorption case 51.

### Other Embodiment

The present disclosure is not limited to the above-mentioned embodiments, and can be modified suitably and variously as follows.

(1) In the above-mentioned embodiments, an example is described in which the in-vehicle heat-emitting apparatus is cooled with the cooling air cooled with the evaporator 13 of the air-conditioning unit 10 corresponding to an in-vehicle equipment, but is not limited to this. For example, when an exclusive-use equipment for cooling an in-vehicle battery is disposed in a vehicle, the heat-emitting apparatus may be cooled with the cooling air cooled by the cooling unit of the exclusive-use equipment.

Moreover, the air-conditioning unit 10 to which the cooling device 50 is applied is not limited to include the evaporator 13 as a cooling unit. For example, the cooling device 50 may be applied to the air-conditioning unit 10 in which a cooling component such as Peltier device is adopted as a cooling unit which cools air.

(2) In the above-mentioned embodiments, HUD 91 and the meter equipment 92 are cooled by the cooling device 50. Alternatively, a display device such as navigation equipment which displays map information may be cooled by the cooling device 50.

It is desirable to cool a display device by the cooling device 50 as above-mentioned in the embodiments. Alternatively, the cooling device 50 may cool a heat-emitting apparatus such as electric motor of the air-conditioning blower 19 and an in-vehicle battery.

(3) In the above-mentioned embodiments, the cold air suction duct 521 of the cooling device 50 is connected to the cold air guiding portion 112 opened in the bottom part of the air-conditioning case 11, but is not limited to this. For example, the cold air suction duct 521 may be connected to the cold air guiding portion 112 defined in the upper surface part or the lateral side of the air-conditioning case 11.

(4) In the above-mentioned embodiments, the adsorption case 51 is connected to the air-conditioning case 11 through each of the suction ducts 521 and 531, but is not limited to this. For example, the cold air suction part 52 and/or the warm air suction part 53 of the adsorption case 51 may be directly connected to the air-conditioning case 11. In this case, the cold air suction part 52 corresponds to a first introductory part, and the warm air suction part 53 corresponds to a second introductory part.

(5) In each of the embodiments, the housing space 541 is partitioned such that the amount of the adsorption material 61 existing in the moisture-adsorbing space 541a becomes less than the amount of the adsorption material 61 existing in the moisture-desorbing space 541b, in consideration of the gap between the adsorption rate and the desorption rate of the adsorption material 61, but is not limited to this.

For example, the amount of the cooling air which circulates the moisture-adsorbing space 541a may be increased to be larger than the amount of the heating air which circulates the moisture-desorbing space 541b. In this case, it becomes possible to fully secure the adsorption amount of moisture to the adsorption material 61 in the moisture-adsorbing space 541a while the amount of the adsorption material 61 in the moisture-adsorbing space 541a is made equal to the amount of the adsorption material 61 in the moisture-desorbing space 541b.

(6) The adsorption material 61 is supported by the plural metal tabular components, as the adsorption unit 60, in each of the embodiments, but is not limited to this. The adsorption unit 60 may include a honeycomb structure, for example, in which the adsorption material 61 is supported.

(7) Although a polymer sorbent is adopted as the adsorption material 61 in each of the embodiments as an example, the present disclosure is not limited thereto. The adsorption material 61 may be silica gel or zeolite.

(8) In the second embodiment, the adsorption unit 60 is continuously rotated in one direction by the electric motor 72 of the drive component 70, causing the adsorption material 61 of the adsorption unit 60 to move between the moisture-adsorption space 541a and the moisture-desorption space 541b. However, the present disclosure is not limited thereto.

For example, the adsorption unit 60 may be intermittently rotated in one direction by the electric motor 72 of the drive component 70, causing the adsorption material 61 of the adsorption unit 60 to move between the moisture-adsorption space 541a and the moisture-desorption space 541b.

The rotational direction of the adsorption unit 60 by the electric motor 72 of the drive component 70 is not limited to one direction, and may be an inverse direction relative to the one direction. For example, the rotational direction of the adsorption unit 60 may be switched between the one direction and the inverse direction relative to the one direction at a predetermined time interval, thereby moving the adsorption material 61 of the adsorption unit 60 between the moisture-adsorption space 541a and the moisture-desorption space 541b.

When the housing space 541 is partitioned such that the moisture-adsorption space 541a has substantially the same size as the moisture-desorption space 541b or the like, switching may be performed between the whole adsorption material 61 existing in the moisture-adsorption space 541a and the whole adsorption material 61 existing in the moisture-desorption space 541b. In this case, the adsorption unit 60 may be intermittently rotated by 180° by the drive component 70.

(9) In each of the embodiments, the drive component 70 which rotates the adsorption unit 60 is adopted as a shift mechanism which causes the adsorption material 61 of the adsorption unit 60 to move between the moisture-adsorbing space 541a and the moisture-desorbing space 541b, but is not limited to this. For example, the adsorption unit 60 may include two or more adsorption parts, and each of the adsorption parts may be made to move in sliding manner between the moisture-adsorbing space 541a and the moisture-desorbing space 541b as the shift mechanism.

(10) In each of the embodiments, the humidification duct 571 corresponding to a first outlet part is desirably produced separately from the air-conditioning duct 20 for air, the temperature of which is adjusted by the air-conditioning unit 10, but is not limited to this. For example, the humidification duct 571 may be integrally formed with the air-conditioning duct 20 of the air-conditioning unit 10.

(11) Like each of the embodiments, the air-air heat exchanger 58 is desirably provided to exchange heat between the cooled air passing through the moisture-adsorption space 541a and the humidification air passing through the moisture-desorption space 541b. However, the present disclosure is not limited thereto. For example, the air-air heat exchanger 58 may be omitted.

(12) It is obvious that in each of the embodiments, elements constituting the embodiments are not necessarily essential particularly unless otherwise specified and except when clearly considered to be essential in principle, and the like. Note that the elements constituting the respective embodiments can be appropriately combined to the greatest extent practicable.

(13) When referring to a specific number about a component, including the number, a numerical value, an amount, a range, and the like in each of the above-mentioned embodiments, the component should not be limited to the specific number particularly except when clearly determined to be essential, and except when obviously limited to the specific number in principle, and the like.

(14) When referring to the shape, positional relationship, etc., of a component or the like in each of the above-mentioned embodiments, the component should not be limited to the shape, positional relationship, or the like unless otherwise specified and except when limited to the specific shape, positional relationship, etc., in principle, and the like.

What is claimed is:

1. A cooling device for an in-vehicle equipment having a cooling unit which cools air, the cooling device cooling an in-vehicle heat-emitting apparatus with the air cooled by the cooling unit, the cooling device comprising:
an adsorption unit including an adsorption material which adsorbs moisture;
an adsorption case that defines a housing space in which the adsorption unit is disposed, the air cooled by the cooling unit passing through the adsorption case, the adsorption material adsorbing moisture from the air; and
a cooling air outlet part that guides a dehumidification air, from which the moisture is adsorbed within the adsorption case, to a target space to be cooled where the heat-emitting apparatus is arranged.

2. The cooling device according to claim 1, wherein
the heat-emitting apparatus is a display which displays information for an occupant.

3. The cooling device according to claim 1, further comprising:
a cabin outlet part which guides air from the adsorption case to a cabin, wherein
the adsorption material has characteristic in which the adsorbed moisture is desorbed by heating,
the adsorption case has a first introductory part that introduces a cooled air cooled by the cooling unit such that the adsorption material adsorbs moisture from the cooled air, and a second introductory part that introduces a low humidity air with low relative humidity and temperature higher than the cooled air such that the adsorption material desorbs the moisture, and
the cabin outlet part guides a humidification air humidified by the moisture desorbed within the adsorption case, to the cabin.

4. The cooling device according to claim 3, further comprising:
a shift mechanism which moves the adsorption material inside the adsorption case, wherein
the adsorption case defines, as the housing space, a moisture-adsorbing space in which the cooled air flows such that the moisture of the cooled air is adsorbed by the adsorption material, and a moisture-desorbing space in which the low humidity air flows such that the moisture adsorbed by the adsorption material is desorbed, and
the shift mechanism moves at least a part of the adsorption material existing in the moisture-desorbing space of the adsorption unit to the moisture-adsorbing space, and moves at least a part of the adsorption material existing in the moisture-adsorbing space of the adsorption unit to the moisture-desorbing space.

5. The cooling device according to claim 4, further comprising:
a heat exchange part in which heat is exchanged between air passing through the moisture-adsorbing space and air passing through the moisture-desorbing space.

6. The cooling device according to claim 1, further comprising:
a dehumidification air outlet part which guides a dehumidification air, from which the moisture is adsorbed within the adsorption case, to a different space different from the target space; and
a passage change part which changes an outlet passage of the dehumidification air between the cooling air outlet part and the dehumidification air outlet part.

7. The cooling device according to claim 1, wherein
the in-vehicle equipment is an air-conditioning unit which blows off air having a controlled temperature to a cabin.

8. An air conditioner for a vehicle comprising:
an in-vehicle equipment including a cooling unit which cools air; and
a cooling device which cools an in-vehicle heat-emitting apparatus with the air cooled by the cooling unit, wherein the cooling device includes
an adsorption unit including an adsorption material which adsorbs moisture,
an adsorption case that defines a housing space in which the adsorption unit is disposed, the air cooled by the cooling unit passing through the adsorption case, the adsorption material adsorbing moisture from the air, and
a cooling air outlet part that guides a dehumidification air, from which the moisture is adsorbed within the adsorption case, to a target space to be cooled where the heat-emitting apparatus is arranged.

9. The cooling device according to claim 6, wherein
the passage change part is configured to operate depending on whether or not it is necessary to cool the heat-emitting apparatus.

10. The cooling device according to claim 9, wherein
the dehumidification air outlet part guides the dehumidification air to a lower side space of a vehicle interior.

11. The cooling device according to claim 3, further comprising:
a controller that executes a humidification process to humidify a vehicle interior, wherein
the controller executes the humidification process when it is necessary to humidify the vehicle interior in case it is unnecessary to cool the heat-emitting apparatus.

12. The cooling device according to claim 3, further comprising:
a controller that executes a cooling and humidification process to cool the heat-emitting apparatus and to humidify a vehicle interior, wherein
the controller executes the cooling and humidification process when it is necessary to cool the heat-emitting apparatus in case it is unnecessary to humidify the vehicle interior.
